(19) United States
(12) Patent Application Publication
(10) Pub. No.: US 2018/0060822 A1
(43) Pub. Date: Mar. 1, 2018

(54) ONLINE AND OFFLINE SYSTEMS FOR JOB APPLICANT ASSESSMENT

(71) Applicant: LinkedIn Corporation, Mountain View, CA (US)

(72) Inventors: Chenying Hou, Sunnyvale, CA (US); Aibo Tian, San Carlos, CA (US); Suman Sundaresh, Los Altos, CA (US); Lee Mallabone, San Francisco, CA (US); Thogori C. Karago, San Francisco, CA (US)

(21) Appl. No.: 15/253,596

(22) Filed: Aug. 31, 2016

(51) Int. Cl. G06Q 10/10; G06F 17/30

(52) U.S. Cl. CPC G06Q 10/1053; G06Q 50/01; G06F 17/3053

(57) ABSTRACT

A system and method includes obtaining, from a database, member characteristics of a member of an online social networking system, obtaining, from the database, job characteristics of a job posted to the online social networking system, and determining, characteristic scores including, for each member characteristic, a characteristic score based on a relationship between the member characteristic and an associated one of the job characteristics. A processor combines the characteristic scores to obtain an aggregate job score, combines a subset of the characteristic scores to obtain a category score, obtains, from the database, aggregate job scores and category scores associated with the job from other members of the online social networking system, and determines an aggregate rank of the aggregate job score in relation to the aggregate job scores and a category rank of the category score in relation to the category scores.

### TECHNICAL FIELD

The subject matter disclosed herein generally relates to online and offline systems for job applicant assessment in an online social networking system.

### BACKGROUND

Job postings to advertise an available job and solicit applications for the job are well known. Job postings have been incorporated into newspapers, periodicals, and the like for centuries. More recently, search engines and websites related to facilitating job searching have presented such available jobs electronically. In such circumstances, entities advertising jobs may receive applications from applicants online, assess the applications, and proceed to make job offers, schedule follow up interviews, ask follow up questions, and so forth.

### BRIEF DESCRIPTION OF THE DRAWINGS

Some embodiments are illustrated by way of example and not limitation in the figures of the accompanying drawings.

FIG. 1 is a block diagram of a system including user devices and a social network server.

FIG. 2 is a block diagram illustrating various components of a social networking server.

FIG. 3 is a block diagram showing some of the functional components or modules that comprise a recommendation engine.

FIG. 4 is a detailed example of the social network server.

FIG. 5 is a depiction of an example user interface screen that can be displayed by the social network on the user device.

FIG. 6 is a flow diagram illustrating an example of the method operations involved in a method of pre-processing user profiles with a characteristic extraction engine.

FIG. 7 is a flow diagram illustrating an example of the method operations involved in a method of generating a relevance between a user profile and a job profile.

FIG. 8 is a flow diagram illustrating an example of presenting a message relating to a job to a user based on an aggregate job score.

FIG. 9 is a flow diagram illustrating an example of an embodiment that permits a user or member of an online social networking system to create a modified profile for use in connection with a job posting service.

FIG. 10 is a flow diagram illustrating an example of an embodiment that automatically recommends employment positions to a user or member of an online social network service.

FIG. 11 is a block diagram illustrating an embodiment that ranks a member of an online social network against others in connection with a current job posting.

FIG. 12 is a block diagram illustrating components of a machine able to read instructions from a machine-readable medium.

### DETAILED DESCRIPTION

Example methods and systems are directed to online and offline systems for job applicant assessment in an online social networking system. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The use of job postings in online social networking systems may tend to create problems of scale which are not encountered in past, conventional job posting circumstances. Where conventional job postings in newspapers, periodicals, and even on conventional websites may generate hundreds or in unusual circumstances even thousands of applicants, social networking systems may routinely generate thousands of applicants with various job postings resulting in far more than that. Moreover, because social networking systems conventionally include relatively rich, private profile information about members of the social networking system, such members may be enabled to interact with job postings in a way that does not necessarily extend to a full application for the job. For instance, the social networking systems may encourage members to review job postings and assess their qualifications for a job posting simply based on their profile information in a way that might quickly determine if basic qualifications are met and an estimate of what the member's changes of success might be if the member applied for the job.

As such, job postings on online social networking systems tend to create circumstances unlike those in other, more conventional job posting environments. The large number of people who might be involved, the richness of private member profile information, and a culture of interaction or encouraging interaction with job postings beyond simply applying for the job create strains on computing resources and challenges regarding the presentation of useful information to members. When and how such information is generated are technical problems outside of the scope of conventional job postings, and the solutions to such problems are not applicable to environments outside of online social networking systems.

In particular, a combination of online and offline systems have been developed to manage member interactions with job postings. The offline system manages, for a job posting, a ranking of members who have applied for the associated job and identifies members of the online social networking system who may be interested in the job. The offline system may also prospectively generate analytic information about a prospective applicant for later presentation to the prospective applicant. The online system manages the presentation of analytic information to members who apply for or otherwise interact with the job posting and generate analytic information for members who interact with the job posting who did not previously have such information available. The analytic information includes a general ranking of the member in terms of relative strength of their member profiles in applying for the job based on multiple individual data points as well as in individual categories using subsets of the individual data points.

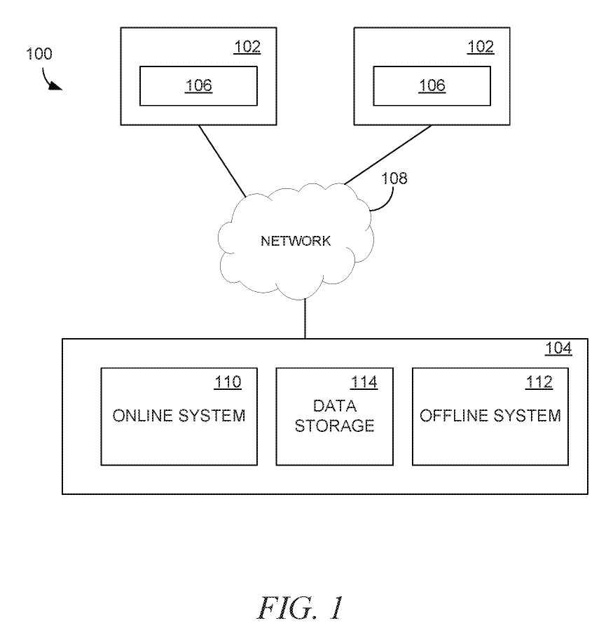

FIG. 1 is a block diagram of a system 100 including user devices 102 and an online social networking system 104, in an example embodiment. User devices 102 can be a personal computer, netbook, electronic notebook, smartphone, or any electronic device known in the art that is configured to display a user interface related to the online social networking system. The user devices 102 can include a network interface 106 that is communicatively coupled to a network 108, such as the Internet. The user devices 102 may be utilized by members of the online social networking system 104 or other users of the online social networking system 104. The online social networking system 104 can be communicatively coupled to the network 108.

In various examples disclosed herein, the online social networking system 104 may be operated as two separate systems, an online system 110 and an offline system 112. Each of the online and offline systems 110, 112 may be implemented as one or more servers and can each be configured to perform activities related to serving the online social networking system 104, such as storing social network information, processing social network information according to scripts and software applications, transmitting information to present social network information to users of the social network, and receive information from users of the social network. The online and offline systems 110, 112 may, in various examples, be implemented on separate servers or may share one or more servers and be logically separated with respect to one another. The online and offline systems 110, 112 may access one or more electronic data storage devices 114, which may be implemented variously as a component of one of the online and offline systems 110, 112, or may be implemented as a standalone electronic data storage system accessible by but maintained outside of the context of any one of the online and offline systems 110, 112.

The online social networking system 104 can store information in the electronic data storage device 110 related to users and/or members of the social network, such as in the form of user characteristics corresponding to individual users of the social network. For instance, for an individual member, the member's characteristics can include one or more profile data points, including, for instance, name, age, gender, profession, prior work history or experience, educational achievement, location, citizenship status, leisure activities, likes and dislikes, and so forth. The member's characteristics can further include behavior or activities within and without the social network, as well as the member's social graph. For an organization, such as a company, the information can include name, offered products for sale, available job postings, organizational interests, forthcoming activities, and the like. For a particular available job posting, the job posting can include a job profile that includes one or more job characteristics, such as, for instance, area of expertise, prior experience, pay grade, residency or immigration status, and the like.

Member characteristics described above can generally include member profile characteristics, in that they are typically defined by a single discrete label, such as a number, a place, or a binary status. Characteristics are included in member behavior, such as can be identified based on member activity within the social network generally. For instance, a member who engages in job searches, such as by entering job keywords into a search engine either of the social network or independent of the social network, can be deemed to have characteristics such as currently seeking a job, and job characteristics that the member is seeking, such as job field, pay grade, location, and the like. Additional member behavior or activities, such as messages to job recruiters, job applications filled out or submitted, and messages to particular companies can also be incorporated. As such, member actions both within and without the social network can be utilized to determine member characteristics such as member behavior.

Activity and behavioral data can be obtained by monitoring and tracking the interactions that a member has with various applications, services and/or content that are provided by, or, integrated or otherwise associated with, the social network service. For example, a social network service may provide any number and variety of applications and/or services with which a member interacts. Similarly, a variety of third-party applications and services may leverage various aspects of the social network service, for example, via one or more application programming interfaces (APIs). A few examples of such applications or services include: search engine applications and services, content sharing and recommendation applications (e.g., photos, videos, music, hyperlinks, slideshow presentations, articles, etc.), job posting and job recommendation applications and services, calendar management applications and services, contact management and address book applications and services, candidate recruiting applications and services, travel and itinerary planning applications and services, and many more.

Analysis of social graph data may signal a member's interest in various job profiles. For instance, in some examples, by analyzing certain social graph data, characteristics can be identified that are suggestive of active job-seeking activity. For example, members who are actively seeking particular jobs may be more likely to follow other members of the social network service, or establish new connections with other members in a very concentrated or shortened time span—particularly other members who are job recruiters for particular job types, or who are associated with a job recruiting function. Similarly, members who are actively seeking jobs of a particular type may be more likely to follow certain companies at which there are open job positions matching the member's skills, or having the same job title as may be desired by the member. Members who are actively seeking particular job types may be more likely to join certain online groups—particularly those groups that exist primarily to aid job seekers. Accordingly, by analyzing social graph data to identify the entities with which a member is establishing associations or connections, and the timing and frequency of the activity, the job-seeking intentions of a member may be inferred, and used in the derivation of a metric representing the member's job-seeking propensity.

In various embodiments, the system 104 includes logic that can identify member profiles (and/or member preferences) that conform to a given job profile. In general, a member profile includes information about the member that is extracted from data in the system about the member or actions of the member on the system (e.g., as noted above, a member may be identified as an active job seeker if the member is visiting job search sites). In general, a member preference includes information that is directly entered into a system by a member, such as a member indicating that he or she is looking for a job with a minimum salary. In various examples, upon receiving a request to identify member profiles (and/or member preferences) similar to a particular job profile, the system may analyze a variety of member profiles (and/or member preferences) to rank member profiles (and/or member preferences) according to aggregate job scores with respect to the job profile as well as according to categories which represent a subset of the member characteristics and/or member preferences that make up the aggregate job score. The identification can be in real-time by the online system 110, understood to be an analysis that is conducted essentially immediately upon initiation by a member or user associated with the job profile, or can be on an ongoing basis by the offline system 112, understood to occur based on decision making by the offline system 112 and without respect to an explicit command by the member or user. After identifying the most similar member profiles and/or member preferences (e.g., those with the highest aggregate job scores), the system 104 may transmit information related to the ranking to one or more members or users, as disclosed herein.

Similarly, the principles described with respect to ranking members according to their aggregate job scores for a particular job may be applied with respect to ranking jobs which are relevant to one member according to that member's aggregate job scores for those jobs. Thus, in an example, the system 104 may, for a member, compute aggregate job scores for that member relative to various jobs. The system 104 may then, for instance, present jobs to the member which correspond to the highest aggregate job scores.

In various examples, the system 104 can present the ranked list of members according to their aggregate job scores. In various examples, a predetermined number of the highest aggregate job scores may be presented. In an example, a user, such as a job recruiter, can identify members who have member characteristics that are desirable for recruiting and manually select members of the social network to whom a message relating to the job can or should be presented.

In various examples, a recommendation service or feature may generate an average member characteristic based on the aggregate member characteristic information of all or some selected members for a particular job. For instance, the recommendation service may select the average member characteristic as an input to the member characteristic matching algorithm, and identify member characteristics that are similar to the model job profile for the job profile. For each member characteristic that is determined to be similar to the average member characteristic for a particular job profile, the recommendation service may recommend to a member having a member characteristic similar to the job profile for the instant job, that the member be presented with the job if the member has not already been so presented.

The ability to accurately identify in real-time or essentially real-time a set of member characteristics (and/or member preferences) most similar to a job profile (or, in various examples, a set of company profiles most similar to member characteristics) can be achieved with a general recommendation engine. Accordingly, at least in some examples, the recommendation engine provides a recommendation service that can be customized for use with multiple applications or services. A recommendation entity can be a collection of information organized around a particular concept that is supported by the system 100 in general, and the recommendation engine in particular. For instance, some examples of recommendation entities are: member characteristics, interest groups, companies, advertisements, events, news, discussions, tweets, questions and answers, and so forth. Accordingly, in some examples, by specifying the particular characteristics of two recommendation entities to be compared, and by specifying a particular algorithm for use in generating an aggregate score, such as in the instant example an aggregate company score, for the two recommendation entities, the recommendation engine can be configured and customized to perform such tasks as: generate aggregate job scores for use in recommending job listings to a member; generate aggregate job scores for use in recommending particular interest groups that a member might be interested in joining; generate aggregate job scores for use in displaying an appropriate or relevant advertisement to a particular member, and many others.

In an example, the recommendation engine operates in two phases. In the first phase, the data representing each individual instance of a particular recommendation entity, such as the member characteristic (and/or the member preference) and the job profile, is processed by a characteristic extraction engine to extract the relevant characteristics on which matching analysis is to be performed. In various examples, in the case of a member profile, only certain characteristics or portions of a member's profile may be selected for use in determining the similarity of any two profiles, such as the member profile and a job profile. As such, during the first phase, a characteristic extraction engine processes each member profile to extract the relevant profile characteristics from each member profile, along with behavior characteristics and social graph characteristics. In addition to simply extracting certain characteristics from relevant recommendation entities, the characteristic extraction engine may derive certain characteristics based on other information included in the recommendation entity, such as from the member profile (or member preference).

In an example, one characteristic that may be used to identify similarities between member profiles (or member preferences) and a job profile is work experience. Work experience may be included as a characteristic in a member profile directly or may be arrived at indirectly, such as by being measured in the number of years since a member graduated from a selected educational institution or achieved a particular educational level. While work experience, in an example, may not be included as raw data in a member's profile, it may be derived with a calculation if the member's graduation date is specified in the member's profile. In addition, in some examples, the characteristic extraction engine may standardize and/or normalize various characteristics, such as a member's job or position title, or the name of a company at which a member has indicated being employed. In some examples, certain profile characteristics may be retrieved from external data sources, using other information included in the recommendation entity as part of a query to the external data source.

The first phase may occur in real-time by the online system 110 or as a background operation in the offline system 112, such as part of a batch process. In some examples that incorporate relatively large amounts of data to be processed, the first phase may be achieved via a parallel or distributed computing platform in the offline system 112. Once the relevant characteristics have been extracted, computed, derived, or retrieved, relevant characteristics of the one or more selected members or jobs can be stored as a pre-processed recommendation entity. For instance, in the case of member characteristics, the characteristic extraction process can result in enhanced member characteristics that include only the relevant characteristics extracted from a member's characteristics as well as any derived or retrieved characteristics, such as profile characteristics. The enhanced characteristics can be used during the recommendation engine's second phase, when the matching engine compares the relevant characteristics from the job profile against each member characteristics set until those member characteristics with the highest aggregate job scores are identified.

In an example, during the second phase, the matching engine of the recommendation engine uses a configuration file that is customized for the particular analysis being performed. For example, a first configuration file (referred to herein as a profile matching configuration file) may exist for use in identifying member profiles similar to a job profile, whereas a second configuration file—specifying different characteristics from different recommendation entities to be compared, and a different algorithm for computing the matching scores—may be specified for determining the job listings that are most likely to be of interest to a particular member. As such, by configuring the characteristic extraction engine to extract relevant data from certain recommendation entities, and customizing the analysis performed by the matching engine with an appropriate configuration file, a wide variety of recommendation operations can be achieved with the general recommendation engine.

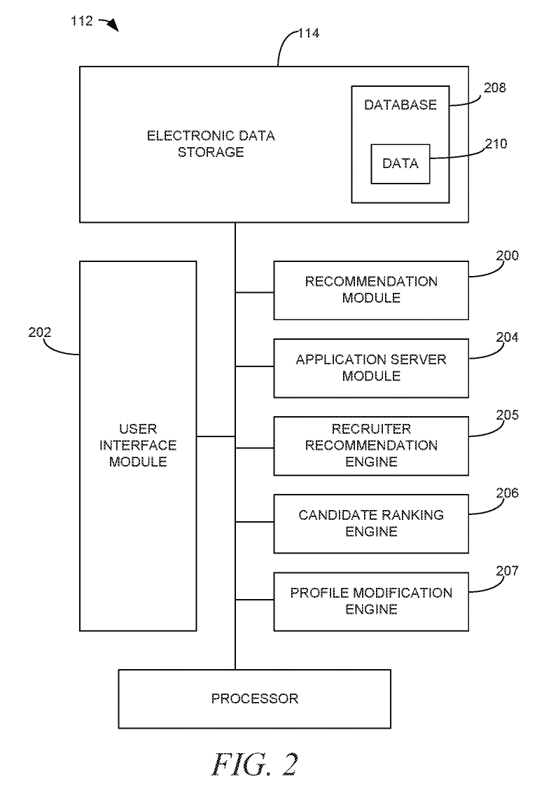

FIG. 2 is a block diagram illustrating various components of the offline system 112, in an example embodiment. The offline system 112 operates on an ongoing or substantially ongoing basis to identify members who are potential job applicants, provide recommendations to members, rank members who have applied or otherwise interacted with a job posting or to whom a job recommendation has been presented with respect to one another, and output information concerning the ranking both in the aggregate and according to separate categories, as disclosed herein.

In the illustrated example, the offline system 112 includes a recommendation engine 200 for identifying similarities between different recommendation entity types, such as member characteristics (and/or member preferences) and job profiles. The front end of the offline system 112 includes of a user interface module (e.g., a web server) 202, which receives requests from various client computing devices, and communicates appropriate responses to the requesting client devices. For example, the user interface module(s) 202 may receive requests in the form of Hypertext Transport Protocol (HTTP) requests, or other web-based, application programming interface (API) requests. The application logic layer includes various application server modules 204, which, in conjunction with the user interface module(s) 200, generates various user interfaces (e.g., web pages) with data retrieved from various data sources in the data layer. With some embodiments, individual application server modules 204 are used to implement the functionality associated with various services and features of the system 100. For instance, the ability to identify member characteristics (and/or member preferences) similar to a job may be a service implemented in an independent application server module 204. Similarly, other applications or services that utilize the recommendation engine 200 may be embodied in their own application server modules 204. Even more specifically, in other embodiments, a recruiter recommendation engine 205 generates a recommendation for a job candidate based on input of a recruiter, a candidate ranking engine 206 generates a ranking of a job candidate compared to other employees and other job candidates, and profile modification engine 207 permits a user or member of an online social networking system to modify his or her profile in the online social networking system. The various components of the offline system 112 may be managed by

In an example, the offline system 112 is based on a three-tiered architecture, consisting of a front-end layer, application logic layer, and data layer. As is understood by skilled artisans in the relevant computer and Internet-related arts, each module or engine shown in FIG. 2 can represent a set of executable software instructions and the corresponding hardware (e.g., memory and processor) for executing the instructions. To avoid obscuring the subject matter with unnecessary detail, various functional modules and engines that are not germane to conveying an understanding of the inventive subject matter have been omitted from FIG. 2. However, a skilled artisan will readily recognize that various additional functional modules and engines may be used with the offline system 112 such as that illustrated in FIG. 2, to facilitate additional functionality that is not specifically described herein. Furthermore, the various functional modules and engines depicted in FIG. 2 may reside on a single server computer, or may be distributed across several server computers in various arrangements.

The data layer can include several databases, such as a database 208 for storing recommendation data, such as member characteristics (and/or member preferences) and job profiles, and can further include additional social network information, such as interest groups, companies, advertisements, events, news, discussions, tweets, questions and answers, and so forth. In some examples, the recommendation entity data is processed in the background (e.g., offline) to generate pre-processed entity data that can be used by the recommendation engine, in real-time, to make recommendations generally, and to identify member profiles similar to a job profile. In an example, the recommendation engine 200 may retrieve and process member characteristic data 210, including a member profile, member behavior, and a member social graph, in the database 208 to identify member characteristics similar to a job profile. The database 208 can store application configuration data, including one or more configuration files for use with the recommendation engine 200.

The online system 110 includes various components of the offline system 112 separately and independently implemented on the online system 110, but in various examples does not include equivalents of the systems or components of the offline system 112. In an example, the online system 110 includes, as components separately implemented from the offline system 112, a user interface module 202, an application server module 204, and a candidate ranking engine 206, operated by a processor, but does not necessarily include implementations of any of the other components of the offline system 112. As such, the online system 110 is functional to rank members for a job posting and display information related to the ranking, as disclosed herein, but does not operate to make recommendations or perform analysis over time.

In various examples, when a person initially registers to become a member (and/or user) of the online social networking system 100, the person can be prompted to provide some personal information, such as his or her name, age (such as by birth date), gender, interests, contact information, home town, address, the names of the member's spouse and/or family members, educational background (such as schools, majors, etc.), employment history, skills, professional organizations, and so on. This information can be stored, for example, in the database 208.

Once registered, a member may invite other members, or be invited by other members, to connect via the system 100. A “connection” may involve a bi-lateral agreement by the members, such that both members acknowledge the establishment of the connection. Similarly, with some embodiments, a member may elect to “follow” another member, entity associated with the social networking system 100, or user generally. In contrast to establishing a “connection”, the concept of “following” another user typically is a unilateral operation, and in some examples, does not require acknowledgement or approval by the user that is being followed. When one member follows another, the member who is following may receive automatic notifications about various activities undertaken by the user being followed.

The online social networking system 100 may provide a broad range of other applications and services that allow a member the opportunity to share and receive information, often customized to the interests of the member. In some examples, the system 100 may include a photo sharing application that allows members to upload and share photos with other members. In some examples, members may be able to self-organize into groups, or interest groups, organized around a subject matter or topic of interest. With some embodiments, members may subscribe to or join groups affiliated with one or more entities, such as companies, schools, social or political organizations, and the like. For instance, with some embodiments, members of the online social networking system 100 may indicate an affiliation with a company at which they are employed, such that news and events pertaining to the company are automatically communicated to the members. In some examples, members may be allowed to subscribe to receive information concerning companies other than the company with which they are employed. With many of these applications and services, one or more recommendation entities may be involved. For instance, in addition to identifying member characteristics that are similar to a job profile, the recommendation engine 200 may be configured and customized to identify groups, companies or photos that are likely to be of interest to a particular member.

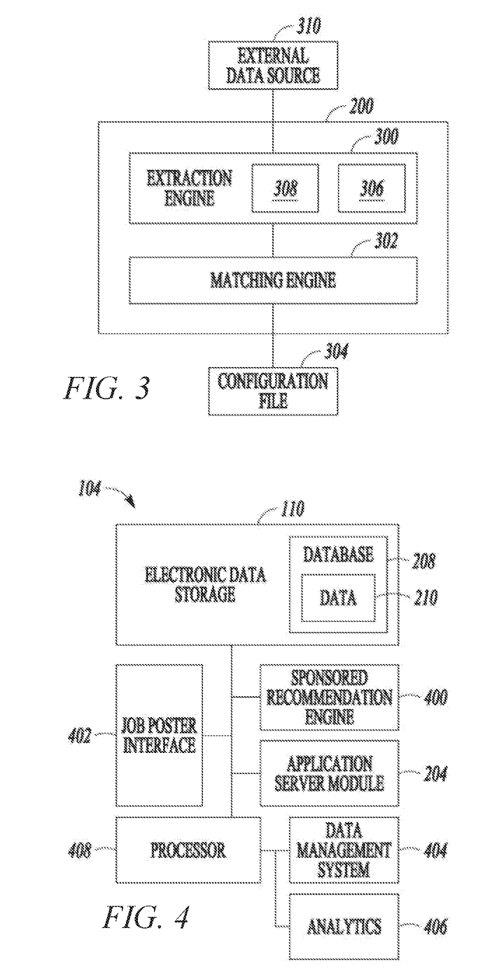

FIG. 3 is a block diagram showing some of the functional components or modules that comprise a recommendation engine 200, in some examples, and illustrates the flow of data that occurs when performing various operations of a method for identifying and presenting member profiles (and/or member preferences) that are similar to a job profile. As illustrated, the recommendation engine 200 consists of two primary functional modules—a characteristic extraction engine 300 and a matching engine 302. The characteristic extraction engine 300 can be customized to extract various characteristics from various recommendation entities, and then operating the matching engine 302 under the direction of a particular configuration file 304 to perform a particular type of matching operation that is specific to the requesting application. Accordingly, depending upon the particular inputs to the recommendation engine 200 and the desired outputs, different configuration files 304 may be used to compare different characteristics of different recommendation entities. For instance, to identify member characteristics that are similar to a job profile, a particular configuration file 304 (referred to herein as a profile matching configuration file) may be used, while different configuration files 304 may be used to perform other tasks, such as identify jobs that a member may be interested in (based on, for example, member preferences).

In the case of identifying member characteristics (and/or preferences) similar to a job profile, the profile matching configuration file 304 is used as an input to the matching engine 302 to specify the various member characteristics that the matching engine is to extract from the pre-processed member profile data 210 and to compare. In addition, the profile matching configuration file 304 can specify an algorithm for comparing characteristics and generating an overall matching score.

In various examples, each member's and job's data 210 is provided as input to the characteristic extraction engine 300, processed by the characteristic extraction engine 300, and then output and stored as pre-processed member characteristic data 210. In some examples, the characteristic extraction engine 300 may extract only relevant characteristics from whatever recommendation entity is being processed by the characteristic extraction engine. So, for example, in the case of a member profile, the characteristic extraction engine 300 may extract only the profile characteristics that are necessary for making the determination of whether a member profile (and/or member preference) is similar to a job profile. However, in some examples, all characteristics are extracted, while only certain characteristics are further processed or refined.

As illustrated, the characteristic extraction engine 300 includes a characteristic derivation module 306 and a data retrieval module 308. In some examples, the characteristic derivation module 306 derives certain characteristics (e.g., profile characteristics, member preferences, behavior characteristics, and social network characteristics) based on the data input to the characteristic extraction engine. For instance, in the case of member profiles or member preferences, the characteristic derivation module 306 may derive one or more profile characteristics from the information included in a member's profile or a member's preferences. Additional member characteristics, such as behavior and social network, may also be derived in this way. Similarly, the data retrieval module 308 may utilize information input to the characteristic extraction engine 300 to formulate a query that is communicated to an external data source 310. As such, the data retrieval module 308 of the characteristic extraction engine 300 can retrieve various profile characteristics from one or more external data sources, such that these retrieved profile characteristics can be used to determine the similarity of any two member profiles.

In addition to deriving various characteristics, and retrieving various characteristics, the characteristic extraction engine 300 can include logic to normalize or standardize certain characteristics, such as profile characteristics. For instance, in some examples, a member may be prompted to provide his or her job title. Because job titles can vary from one company to the next, and from one industry to the next, job titles may be normalized or standardized. For example, the simple job title, “analyst” may have very different meanings in different industries. By normalizing and/or standardizing the job titles and then writing the standardized and normalized job titles to each member's enhanced characteristics, the recommendation engine can make meaningful comparisons, and thereby provide relatively accurate results when presenting member profiles similar to a job profile.

After the characteristic extraction engine 300 has generated the pre-processed member characteristic data 210, the matching engine 302 is able to process client requests to identify member characteristics (and/or member preferences) similar to a job profile. In some examples, the client of the matching engine 302 may simply be a server-side application that is requesting the information from the matching engine 302. Accordingly, the requesting application may specify or determine the particular configuration file that is to be used by the matching engine 302 to perform the requested task and achieve the requested objective. When a request is received at the matching engine 302 to provide a list of member characteristics similar to a job profile, the matching engine 302 can use the profile matching configuration file 304 to determine the particular member characteristics that are to be retrieved from the various enhanced member profiles. In addition, in various examples, the profile matching configuration file 304 can specify the exact comparisons that are to be performed, and how the overall matching score is to be calculated. Accordingly, the particular profile matching configuration file 304 can include instructions or directives for use by the matching engine 302 to perform the necessary characteristic comparisons, and to generate the aggregate job scores for each member profile, such that the aggregate job score for each member characteristic data indicates the similarity of the member characteristics with respect to the job profile.

In some examples, the matching engine 302 can compare multiple individual characteristics such that each compared characteristic results in an aggregate job score (referred to herein as a sub-score, to reflect that the sub-score is a component of the overall aggregate job score). Once each sub-score is determined, the sub-scores are combined in some manner indicated by the profile matching configuration file 304. That is, the profile matching configuration file 304 may dictate how the matching engine 302 is to weigh and combine the individual similarity sub-scores to derive the overall aggregate job score for various member characteristics.

FIG. 4 is a detailed example of the online social networking system. The online social networking system includes a sponsored recommendation engine 400. The recommendation engine 400 can incorporate the recommendation engine 200 or can be an adapted form of the recommendation engine 200. In various examples, the recommendation engine 400 includes characteristic comparison capabilities between member characteristics (and/or member preferences) and job profiles.

The server 104 can include a job poster interface 402, such as with a user interface coupled to the server 104 or via the network interface 106. The user interface can include a conventional keyboard and display configuration well known in the art. The job poster interface 402 provides an interface for the posting of jobs, including a corresponding job profile, on the social network.

The job poster interface 402 is coupled to a data management system 404. The data management system 404 can incorporate data management technologies well known in the art or can incorporate proprietary data management structures. In an example, the data management system 404 incorporates SAS, or Statistical Analysis System data management systems, to promote business analysis, statistical analysis, data storage and recovery, and the like for job information. The data management system 404 can include the capacity for social network administrators to utilize the data generated by the data management system 404, such as by inputting tasks into the data management system 404.

The job poster interface 402 and the data management system 404 can both be coupled to the database 208. The job poster interface 402 can transmit job data, such as job profiles, to the database 208 for storage without respect to data management activities. The data management system 404 can store job data in the database 208 upon the job data having been acted upon for data management analysis.

The network interface 106 can provide the input of member data, such as member characteristics, into the social network. The member characteristics can be stored in the database 208 or can be directly transmitted to the recommendation engine 400 for cross reference against the job profiles stored in the database 208. Jobs identified by the recommendation engine 400 can be transmitted via the network interface 106 to the user device 102 for presentation to the member.

A job analytics system 406 can track the occurrence of jobs that have been presented to or selected by a member. The job analytics system 406 can track how many times a job has been presented, how many times a job has been selected or “clicked” on by a member, bill a job presenting entity accordingly, and adjust the remaining number of times the job has left to be presented or selected accordingly.

The job analytics system 406 can further monitor which jobs are posted to members to seek to prevent job postings from being duplicated to a single member, as well as record analytical information related to the number of times, for instance, that a presented job has been clicked on by a member and the member characteristics of members who have clicked on job presentations. In various embodiments, the job analytics system 406 can present the same job to the same member a predetermined number of times or until the member clicks on the job to learn more. The job analytics system 406 can further terminate job bids that, for instance, meet a termination date or are being presented to members unsatisfactorily frequently or unsuccessfully. Additionally, the job analytics system 406 may be utilized to renew or extend job bids, such as at the direction of the job presenting entity or the social network administrator.

In various examples, the database 208 incorporates multiple job profiles, each of the job profiles individually corresponding to one job for which an entity that has a corresponding job to offer. The recommendation engine 400 is configured to determine an aggregate job score for at least some of the job profiles in the database 208 by incorporating a relevance of the job profiles to member characteristics using the recommendation engine 400 and a potential job bid corresponding to each job profile.

In various examples, when a member accesses the social network, the recommendation engine 400 cross references the member's characteristics (and/or the member's preferences) against some or all of the job profiles in the database 208. The recommendation engine 400 can generate a relevance for each of the cross referenced profiles. The recommendation engine 400 can utilize a processor 408 (in various examples, the processor 408 is the processor 112 of the system 100) can manipulate the relevance for the job profile. In various examples, any combining mechanism or process can be utilized to produce the aggregate job score.

In various examples, the relevance of a job profile to a member may factor in previous success that the job posting has had with other members. If a large percentage of members who are presented with a job posting based on the job profile select the job posting for more information, then the job posting may be deemed more relevant. A so-called “click-through rate” that exceeds a threshold may result in the relevance of the job posting being increased, while a click-through rate less than a threshold may result in the relevance of the job posting being reduced.

Relatedly, the characteristics of other members of the social network who do select a job posting for more information can also be incorporated into determining the relevance for a particular member. Characteristics of members who have selected a particular job posting in the past can be compared against member characteristics (and/or member preferences) of a prospective member. To the extent that member characteristics of a prospective member are or are not related to the member characteristics of members who have selected a job posting in the past, the relevance of the job posting may similarly be increased or decreased for a prospective member. As such, the server 104 may store characteristics of members who have selected the job posting in the past and may develop composite member characteristics. The degree to which the characteristics of a prospective member match the composite characteristics may weigh the results of the recommendation engine more heavily for a given prospective member.

In various examples, the recommendation engine 400 does not present a job to a member unless the relevance of the job profile to the member characteristics (and/or member preferences) is greater than a minimum threshold. In such examples, it may be undesirable to display jobs that are unsuitable to a particular member to that member.

FIG. 5 is a depiction of a user interface screen 500 that can be displayed by the social network on the user device 102 corresponding to a member. In an example, the user interface screen 500 is a sub-portion of a larger user interface screen displaying additional information related to the social network. The user interface screen 500 is configured to display rankings of a member relative to other members who have applied for a job. The user interface screen 500 may be generated by either the online system 110 or the offline system 112, depending on which system 110, 112 determined the ranking.

The user interface screen 500 may be generated according to any of a variety of circumstances. In one example, upon the recommendation engine 400 having identified jobs to present to a member and the ranking engine 206 having ranked a member against other applicants for a job, the user interface module 202 of the offline system 112 may generate the user interface screen 500 to a qualified candidate as an illustration of where the member would rank if the member applied. In another example, the online system 110 may generate the user interface screen 500 upon a member viewing a job, asking for more information about a job, or applying for a job. In another example, if a job applicant has applied but did not, at the time of applying, view the ranking, then the offline system 112 may generate the user interface screen 500 and/or the statistics related to the user interface screen for display to the applicant in the event that the applicant subsequently checks ranking statistics at a later time.

The user interface screen 500 includes a job information field 502 which may include, for instance, an organization offering the job, a title, a location, a salary range, and other relevant information to the job itself, as desired. The user interface screen 500 further includes an analytics field 504. In various examples, the analytics field 504 may be displayed upon a user viewing the job, or may be accessible from a link, tab, or other mechanism known in the art. As such, in various examples, the analytics field 504 may be shown automatically, in which case the ranking information and other information displayed in the analytics field 504 may be generated by the online system 110 if not yet generated by the offline system 112 every time a member views a job, or the ranking information may be generated by the online system 110 upon the member deliberately and separately choosing to view the analytics field 504 if the ranking information has not already been generated by the offline system 112.

In the illustrated example, the analytics field 504 includes information about the job, including a number of people who have applied for the job and over what time period. An addition, the analytics field 504 includes an aggregate rank 506 and category ranks 508 of the member relative to the other members who have applied for the job. The presentation of the ranks 506, 508 may be prospective of applying for the job (“If you applied for this job . . . ”) or reactive to having applied for the job (“You are ranked . . . ”). Each of the ranks 506, 508 are calculated according to the ranking mechanisms disclosed herein, though with different member characteristics. The aggregate rank 506 is based on a set of member characteristics while each category rank 508 is based on a different subset of the set of member characteristics.

In an example, the set of member characteristics includes member skills overall; member skills against a standardized list; current job titles; past job titles; member personal summary; current job summary; current job skills; past job summary; past job skills; current title; past titles; current industry; past industry; and member summary. The category ranks 508 are based on some or all of: Title, using the current job titles, past job titles, current title, and past title characteristics; Summary, using the member personal summary, current job summary, past job summary, and member summary characteristics; Skills, using the member skills overall, member skills against a standardized list, current job skills, and past job skills characteristics; and Industry, using current industry, current industry SIM, and past industry characteristics. The categories presented here are not exhaustive and it is to be recognized and understood that any category including any desired characteristics may be created. Moreover, while in the illustrative example the various characteristics of the set are used in only one category each, it is to be understood that characteristics may be utilized in more than one category.

The member skills overall characteristic may be any skill associated with the member in the member's profile characteristics. Thus, the member or other members of the online social networking system 100 may assert that the member has a skill in, for instance, typing, accounting, mathematics, baseball, human resources, graphic design, etc. For member skills overall, any skill attributed to the member may be factored in. By contrast, the member skills against a standardized list may utilize only those member skills which match a skill set specific to the job posting. Thus, for a computer programmer position, the standardized list may include various computer programming languages in the list of skills but not accounting.

The presentation of the ranks 506, 508 in the analytics field 504 may be according to any of a variety of formats and/or desired presentation mechanisms. For instance, the ranks 506, 508 may show a direct percentage rank of the member relative to other members, e.g., “You are in the 87^{th} percentile.” Alternatively, the percentage may be indicative of a tranche in which the member is ranked, e.g., “You are in the top quartile.” Further alternatively, the rank 506, 508 may be a direct rank, e.g., “You are fourth of 392 applicants”, or a tranche rank, e.g., you are in the top one hundred of approximately four hundred applicants.” Additionally or alternatively, a rank 506, 508 may be presented graphically, e.g., by showing four out of four bars to indicate that the member is in the top quartile or by showing a pie chart indicative of the percentage rank of the member, among any of a variety of graphic mechanisms for displaying rank or percentage that are known or may be developed.

In various examples, any rank may be displayed, or a rank may be required to meet a threshold. For instance, only ranks 506, 508 which are in the top half may be displayed to a member. If a particular rank 506, 508 is in the bottom 50 percent then the aggregate rank 506 and/or an individual category rank 508 may be omitted from the analytics field 504 and not presented to the member.

The user interface screen 500 may include any of a variety of additional information. For instance, the user interface screen 500 includes a job application button 510 to allow a member to apply for a job in the event the member has not previously applied for the job with the associated ranks 506, 508, e.g., the job is a recommended job and not a job the member has already applied for. A recommended jobs field 512 may present additional jobs recommended for the member, including a rank for the member if the member did apply for the job.

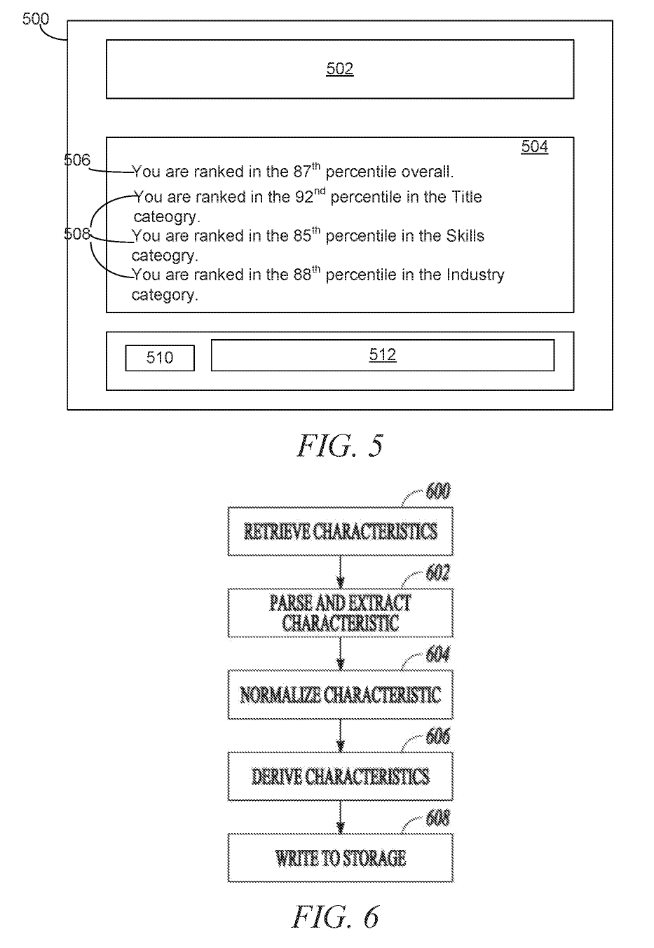

FIG. 6 is a flow diagram illustrating an example of the method operations involved in a method of pre-processing member characteristics (and/or member preferences) with a characteristic extraction engine to generate enhanced characteristics for use by a matching and/or ranking engine. In some examples, some of the method operations illustrated in FIG. 6 may be performed by the offline system 112 by means of a batch processor that is performed periodically (e.g., two times a day, daily, weekly, and so forth), while in other examples, the method operations may be performed by the online system 110 in real-time as requests for similar member characteristics and job profiles are being received and processed.

At 600, the relevant characteristics (and/or preferences) for a member or job profile are retrieved. In some examples, the characteristic extraction engine is configured to extract only certain characteristics from each member's characteristics information. Accordingly, the characteristic extraction engine may simply retrieve from a database the relevant data corresponding to the relevant characteristics. In some examples, the retrieval may be performing a database look-up or fetch of the relevant data.

At 602, as some profile characteristics may be free-form text (i.e., unstructured data), such as a description of a member's interest, skills, hobbies, career objectives, and so forth, some of the relevant characteristics that have been retrieved are parsed and extracted from their raw data format.

At 604, one or more processes may be performed to either normalize or standardize one or more profile characteristics. For instance, a member's job title may be standardized so that it can be more easily compared with others. Similarly, the name of a company that employs a member may be normalized, for example, to drop or add “Inc.” or “Corporation” and so forth.

At 606, the characteristic extraction engine 300 may derive one or more characteristics from raw data included in a member's or job's profile. For example, in some examples, one or more enhanced characteristics may be characteristics that are derived from the raw data included in a member's characteristics (or member's preferences). If, for example, a member's profile indicates the year that he or she graduated from college, an enhanced characteristic that can be derived from this raw data may include the number of years of work experience after college. In addition, some characteristics may include data received from a data source external to the system 100. Accordingly, data from a member's profile (e.g., a name, or other identifying data) may be used to query an external data source for additional information about the member.

At 608, the relevant characteristics, including characteristics such as extracted characteristics, derived characteristics, normalized or standardized characteristics, or retrieved characteristics are written to storage as pre-processed, enhanced member characteristics.

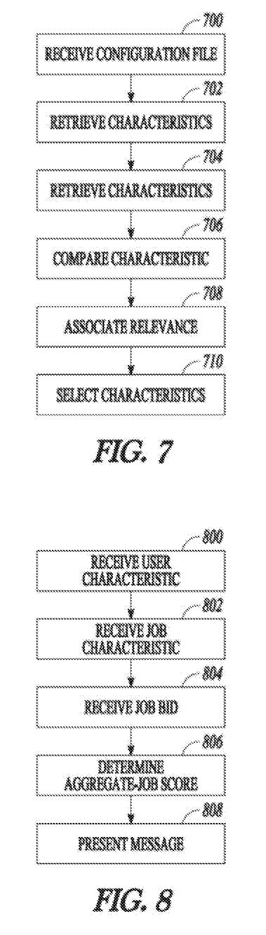

FIG. 7 is a flow diagram illustrating an example of the method operations involved in a method of determining the relevance between member characteristics and a job profile with a matching engine 302.

At 700, the recommendation engine 200 receives, retrieves, or otherwise reads or processes a profile matching configuration file. The profile matching configuration file, which may be a document formatted in Extensible Mark-up Language (XML) or in some other format, specifies the particular characteristics (or data elements) that are to be extracted or retrieved from a particular recommendation entity, such as enhanced member characteristics (and/or enhanced member preferences). For example, in assessing the relevance of member characteristics to a job profile, the names of the person and the job may not play a role in determining the similarity of the profiles. As such, the profile matching configuration file may not include member's names as a characteristic to be extracted and compared. However, technical skills or professional organizations may be relevant to the analysis, and as such, these characteristics may be specified in the profile matching configuration file, such that the data representing these characteristics are ultimately retrieved and analyzed by the matching engine 302.

As discussed below, the profile matching configuration file specifies the particular characteristics to be retrieved as well as the particular matching algorithms to be used for each of the retrieved characteristics. For example, the profile matching configuration file indicates an algorithm or comparison operations that are to be performed for the various characteristics specified in the matching configuration file, and how the various similarity sub-scores, resulting from the comparison of individual characteristics, are to be combined to generate an overall relevance. In some instances, the profile matching configuration file may indicate that a particular comparison is to be performed for a particular characteristic that results in a match only when there is an exact match. In other instances, a partial match may be indicated, and so forth. In some instances, the comparison may involve determining whether a particular member characteristic is within a particular distance of the same job profile characteristic and so forth. As such, the matching profile may indicate not only the type of matching operation to be performed between a particular pair of characteristics, but also the weight that should be applied to any resulting sub-score generated as a result of a match occurring between two characteristics. In some examples, the weight applied to any particular sub-score may be dependent upon the extent to which two characteristics match, as specified by a matching algorithm or rule in the profile matching configuration file.

At 702, the relevant characteristics for one of the member characteristics (and/or member preferences) and the job profile are retrieved. In some instances, the job profile may be selected by a member, while in other instances, an application or process selects a particular job profile. In any case, the relevant job profile characteristics for the selected job profile are those job profile characteristics specified in the profile matching configuration file obtained at 700. In some examples, each member and job profile may have an identifier (e.g., such as a member or job identifier, or, member or job profile identifier). Accordingly, a request to identify job profiles similar to member characteristics may include an identifier identifying the job profile. With this, the matching engine 302 can retrieve the necessary characteristics from the pre-processed, enhanced member or job profile for the particular member or job identified by the member or job identifier, as the case may be.

At 704, the matching engine retrieves the same set of characteristics for the other of the member characteristics (and/or member preferences) or job profile not retrieved at 702. In some examples, the particular member or job profiles that are compared may be selected based on some required matching criteria, either by default, or as specified by an application, process or member who has initiated the request. For instance, the matching analysis may be limited to only those members or jobs that share a particular characteristic in common with the profile selected in 702, such as having the same job title, or experience requirement. In other instances, the entire set of member characteristics or job profiles may be considered.

At 706, the matching engine 302 compares the various characteristics and calculates the relevance for the member characteristics (and/or member preferences) and the job profile in accordance with the instructions or directives set forth in the profile matching configuration file. For instance, the profile matching configuration file indicates what comparison operation is to be performed for a pair of characteristics, and how the various similarity sub-scores are to be combined to derive the overall aggregate job score.

At 708, the relevance is associated with the member characteristics (and/or the member preferences). The process of operation 706 may be repeated for additional job profiles, until all of a particular set of job profiles have been assigned relevance scores.

At 710, once all the job profiles have a relevance score, indicating a level of similarity to the member characteristics (and/or the member preferences), a certain number of the job profiles with the highest aggregate job scores are selected for use with the recommendation engine 400. In some examples, the number of job profiles that are selected and provided for use with a requesting application may be determined using some default or predetermined number. Alternatively, in some examples, the number of member characteristics that are selected and provided to a particular requesting application may be configurable so that a certain number of the member characteristics with the highest relevance scores are provided. For example, in some examples, the profile matching configuration file specifies the number of member characteristics that are to be returned to the requesting application. The number of member characteristics may be specified explicitly (e.g., ten, thirty, one-hundred), or via a rule, such as, the top “X” number of member characteristics, or all member characteristics with a matching score exceeding “X”, or some combination.

FIG. 8 is a flowchart for presenting a message relating to a job to a member or member of an online social networking system based on an aggregate job score. The flowchart is discussed herein with respect to the system 100, but can be implemented on any suitable system.

At 800, a member characteristic (and/or member preference) is received by the processor 112. In various examples, multiple member characteristics are received by the processor 112. The member characteristic can be received via network interface 106, can be obtained from the electronic data storage 110 of the system 100, or can be received as input from a direct physical connection to the system 100, among other possible input methodologies known in the art.

At 802, a job characteristic of a job profile of a job is received by the processor 112. In various examples, multiple job characteristics of the job profile are received by the processor 112. The job characteristic can be received via the job poster interface 402, such as via the network interface 106, from the electronic data storage 110 of the system, or can be received as input from a direct physical connection to the system 100, among other possible input methodologies known in the art. In various examples, job characteristics from multiple job profiles can be received.

At 804, a job bid is received from an entity related to the job, such as a job posting entity that posted the job to the social network. In various examples, the job bid can include a monetary bid for a number of times a message related to the job is posted on a user device 102, a number of times a member selects or “clicks” on the message, an amount of money the job posting entity is willing to pay for each time a job message is presented, selected, or otherwise interacted with, a total amount of money the job posting entity is willing to pay, a duration of time the bid is active, and so forth as disclosed herein. In various examples, multiple job bids from multiple jobs can be received.

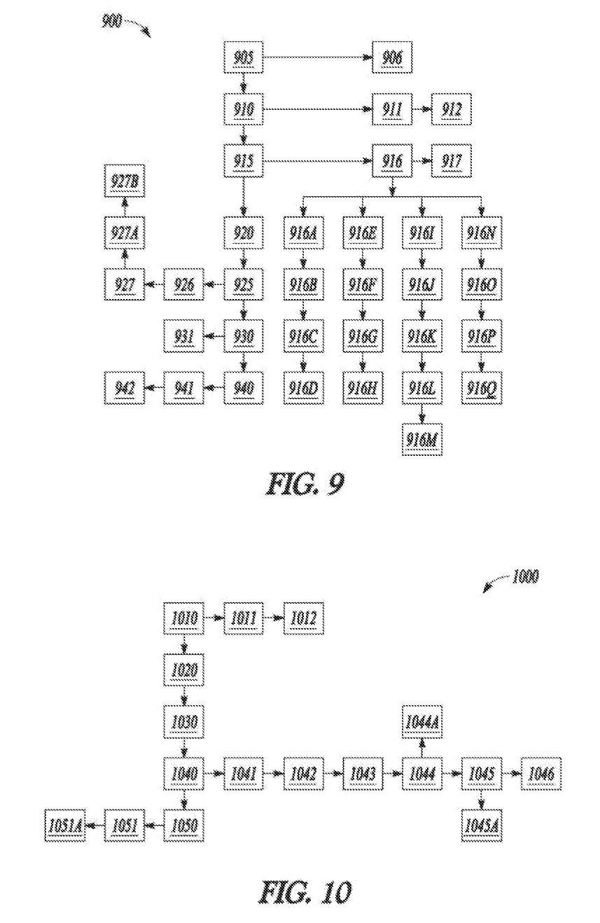

At 806, the processor 112 determines an aggregate job score for the user or member based on the relevance of the job characteristic to the member characteristic (and/or member preference) and the job bid. The relevance can be determined according to the methodology of FIG. 9 and as disclosed herein. Relevance can be determined as a percentage of matching ones of the member and job characteristics that comprise the member and job profiles, respectively. The aggregate job score can be arrived at by applying the bid to the relevance. In various examples, the relevance is multiplied by the bid to arrive at the aggregate job score.

At 808, a message relating to the job is presented to the member based, at least in part, on the aggregate job score. In various examples, the message is presented as illustrated on the interface screen 500. In various embodiments, the message includes an internet web link to further information. As shown on the interface screen 500, presentation of the message related to the job can be organized on the interface screen 500 as an ordered list according to which job has the largest aggregate job score. In various examples, multiple messages related to different jobs are presented with respect to one another based on their respective aggregate job scores, such as by placing higher magnitude aggregate job scores relatively more prominently on the interface screen 500. In various examples, only jobs that have relevance with a magnitude greater than a predetermined threshold are presented to the member.

FIG. 9 is a block diagram illustrating operations and features of a system and method for permitting a user or member of an online social networking system to create a modified profile for use in connection with a job posting service. FIG. 9 includes a number of feature blocks and operation blocks 905-942. Each block of FIG. 9 includes a reference number that corresponds to a reference number in the following paragraphs. Verbal descriptions are not included in the blocks of FIG. 9 in order to increase the readability of FIG. 9. Though arranged substantially serially in the example of FIG. 9, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIG. 9, at 905, an online social networking system maintains a member characteristic of a member. The term online social networking system includes online business networking services. In some situations, the term member refers to a person who is a registered member of the online social networking system and who has a member profile associated with the online social networking system. A user of the online social networking system 100 may not be registered with the online social networking system, but still uses the service. In other situations, a user may be a registered user and have a profile associated with the online social networking system. The member characteristic can be part of a member profile of the online social networking system (906).

At 910, a job characteristic of a posted job profile is maintained. The posted job can be posted via a job posting service, or as indicated at 911, the posted job can be posted by the online networking service. At 912, the job profile of a posted job is saved to a computer storage device associated with the online social networking system. At 915, the online social networking system receives an input from the member to modify the member characteristic. The modification of the member characteristic can be executed by the profile modification engine 207. Examples of member characteristics that a member can modify include geographic location, job position or title, company size, and an industry (916). At 917, the modified member characteristic is stored as a member preference in connection with the online social networking system. At 920, the online social networking system compares the modified member characteristic with the job characteristic. At 925, the online social networking system transmits a message to the member based on the comparison of the modified member characteristic with the job characteristic.

These features allow a member of an online social networking system to search for and/or be contacted for available positions that do not entirely match up with the member's profile or member characteristics. For example, if the member's profile indicates that the member is currently living in a particular geographic location, but the member wants to relocate to a different geographic location, the member can indicate such a preference by altering his or her member characteristics. In this manner, the online social networking system will not limit the member to his or her current geographic location (contained in the member's profile or characteristics) when comparing current employment positions with the member's profile. As another example, the member may currently work for an established, relatively large company, but the member may now be interested in working for a smaller startup company. The member can modify his or her member characteristics to reflect this desire. These modified member characteristics can be stored as member preferences.

Blocks 916A through 916Q illustrate additional features of the online social networking system in connection with modifying member characteristics such as geographic location, job position, job title, company size, and industry.

Referring to blocks 916A through 916D, the online social networking system defaults the geographic location to a geographic location stored in the profile of the member (916A). This is the normal or typical state of the service prior to a member modifying any of his or her member characteristics. At 916B, the online social networking system displays a user interface to the member. At 916C, the online social networking system receives via the user interface a new geographic location from the member. This new geographic location is different from the geographic location that is currently in the member's profile (which may have been extracted from the member's residential address or business address). At 916D, the online social networking system sets the geographic location in a member preference to the new geographic location entered by the member. The online social networking system can also store in the member preference a geographic area that is associated with or related to the new geographic location that was entered by the member. In this manner, while a member may enter San Francisco as the geographic area, the online social networking system can create a member preference that includes the greater San Francisco Bay Area.

Referring to blocks 916E through 916H, at 916E, the online social networking system defaults the job position and title to a job position and title stored in the profile of the member. At 916F, the online social networking system displays a user interface to the member, and at 916G, the online social networking system receives a new job position and title from the member via the user interface. At 916H, the online social networking system stores the new job position and title entered by the member in a member preference. This feature permits a member to search and/or be considered for posted job positions that are outside of the types of job positions in his or her member profile.

Referring to blocks 916I through 916M, at 916I, the online social networking system defaults to all company sizes. Consequently, when the online social networking system compares the member's characteristics to job postings, companies of all sizes will be considered for the member. In an alternative embodiment, the member's characteristics will contain a company size that is comparable to the current company with which the member is employed. At 916J, the online social networking system displays a user interface, and at 916K, the online social networking system receives a selection of a company size from the member. At 916L, the online social networking system stores the selection of the company size in a member preference. As indicated at 916M, the user interface can be a slider bar, wherein the slider bar presents to the member on the user interface a range of company sizes for selection by the member and subsequent storage in the member's preference.

Referring to blocks 916N through 916Q, at 916N, the online social networking system defaults the industry to an industry stored in the profile of the member. Consequently, when the online social networking system compares the member's characteristics to job postings, job postings in the member's current profile will be considered for the member. At 916O, the online social networking system displays a user interface to the member, and at 916P, the online social networking system receives a selection of a new industry from the member. At 916Q, the online social networking system stores the selection of the new industry from the member in a member preference. This preferred industry of the member can now be used when comparing the member to posted job listings.

At 930, the online social networking system determines that the member has never modified the member characteristic. In such a situation, at 931, the online social network service displays a user interface permitting the member to modify the member characteristic.

In a similar manner, at 940, the online social networking system determines a date on which the member last modified the member characteristic. At 941, the online social networking system compares the date to a threshold date. When the date is prior to the threshold date, then at 942, the online social networking system displays a user interface to the member permitting the member to modify the member characteristic.

At 926, the online social networking system transmits the message relating to the comparison of the modified member characteristic and the job characteristic to the member on a periodic basis. That is, in an embodiment, the online social networking system is continuously searching for job positions for a member, and whenever such positions are located, information relating to those positions is transmitted to the member. At 927, the message transmitted to the member includes a page associated with the online social networking system. The page can include an icon identifying a company with an employment position and a link to information relating to the employment position. At 927A, the online social networking system permits the member to hide or discard a displayed employment position, and at 927B, the online social networking system permits the member to undo a decision to hide or discard the displayed employment position.

FIG. 10 is a block diagram illustrating operations and features of a system and method that determines whether an employer would be interested in a particular person for employment, and if that employer is interested, notifying the person of the employer's interest. In an embodiment, the checking with the employer is done without the knowledge of the person, and results in the person being informed of an employer that is interested in the person. FIG. 10 includes a number of feature blocks and operation blocks 1010-1051A. Each block of FIG. 10 includes a reference number that corresponds to a reference number in the following paragraphs. Verbal descriptions are not included in the blocks of FIG. 10 in order to increase the readability of FIG. 10. Though arranged substantially serially in the example of FIG. 10, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

More specifically, FIG. 10 illustrates a flow diagram of an embodiment that automatically recommends employment positions to a user or member of an online social network service. The online social network service compares a member profile to the requirements of an available employment position, and if there is a match, the online social networking system transmits the member profile to the employer. If the employer would like to explore employment opportunities with this member, then the employer informs the online social networking system, and the online social networking system in turn informs the member. In contrast to a system that may compare a member's credentials to an available employment position and suggest one or more jobs to the member, this embodiment automatically (with or without member's permission) transmits the member's profile to the employer. That is, when the online social networking system sends the member's profile to the employer, the member has basically automatically already passed the “resume filter” in connection with this available employment position (that is, the member has been “pre-cleared” for the next step in seeking this available employment position), and this current available employment position may not be simply a job that the member may be interest in, but a job that is interested in the member.

Referring specifically now to FIG. 10, at 1010, a profile of a person is maintained in a computer database. As indicated at 1011, the database and profile can be associated with an online social networking system. The profile can be of a member of the online social networking system. A member of an online social networking system can be a person who is a registered user of the online social networking system, and for whom the online social networking system maintains a profile. In another embodiment, a non-member or non-registered user could also benefit from the automatic job matching capabilities of this embodiment, as long as the user provides personal, education, and employment history information to the online social networking system. At 1012, it is noted that the profile of the user or member can include a work history, an education history, a social connections history, and a business connections history. As such, the term online social networking system includes purely social network services, purely business network services, and hybrids of social networking services and business networking services.

At 1020, the online social networking system receives from an employer requirements for a particular employment position that the employer is trying to fill. In an embodiment, these employment position requirements can be entered by the employer via the user interface module 202, and stored as data 210 in the database 208. The employer may or may not be a user-entity or member-entity of the online social networking system.

At 1030, the recommendation engine 200 compares the profile of the member to the requirements for the employment position. These employment position requirements can include, for example, education requirements, work experience requirements, technical expertise requirements, and geographic requirements. At 1040, the recommendation engine determines if there is a match between the requirements of the employment position and the profile of the member. The degree of match between the employment requirements and the member profile can be programmed per the desires of the employer. For example, the employer may require that there is a match between the requirements and the member in all of the categories of the requirements. When the profile of the person matches or exceeds the requirements for the employment position, the recommendation engine 200 transmits a message to the employer containing the profile of the person.

At 1041, the online social networking system seeks permission from the member before sending the member's profile to the employer. In this embodiment, the transmission of the member profile to the employer is not automatic. Rather, the member must first opt in to the service of having his or her profile sent to an employer when his or her profile matches with the requirements of an open employment position. This embodiment can be directed to an active job seeker, that is, one who is currently and actively seeking a new employment position. That is, the member is informing the online social networking system that he or she is actively looking for a new employment position.

At 1042, the online social networking system transmits the message to the employer containing the profile of the person without receiving permission from the person. This embodiment can be directed more to a passive job seeker. That is, a member who is not really actively looking for a new job, but one who would consider a new opportunity if presented with one.

At 1043, an embodiment relates to a feature wherein the online social networking system conceals the identity of the member prior to transmitting the message to the employer. The member may prefer this embodiment, irrespective of whether the member is an active job seeker (1042) or a passive job seeker (1041).

At 1044, an embodiment relates to a feature wherein the online social networking system inquiries, before sending the member's profile to an employer, whether or not the member would like his or her profile sent to a particular employer. If the member provides permission to the online social networking system to send his or her profile to the employer, the online social networking system transmits the member's profile to the employer. If the member does not provide permission, the member's profile is not sent to the employer. This embodiment allows the member to approve/prevent the sending of his or her profile to employers on an employer by employer basis. In this manner, if there is a particular employer for whom the member would not like to work, then this feature prevents the member's profile from being sent to that particular employer. At 1044A, the online social networking system provides the option to the member of having the member's identity revealed to the particular employer. In this embodiment, the member may be extremely interested in a particular employer and/or a particular employment position, and he or she may feel that revealing his or her identity to the employer may exhibit that interest to the employer.

At 1045, the online social networking system transmits a message to the member indicating that his or her profile matched or exceeded the requirements of the open employment position. Then, at 1045A, the online social networking system will provide the profile of the member to the employer within a certain time period after transmitting the message to the member that indicates the matching or exceeding of the member's profile with the employment requirements, unless the person indicates within the certain time period to refrain from transmitting the profile of the person to the employer.

At 1046, prior to the comparison of the profile of the member to the requirements for the employment position, the online social networking system normalizes the data in the member's profile and normalizes the data in the requirements for the employment position. This normalization permits a more accurate comparison between the member profile and the employment requirements. For example, a member may list “web site development” as a skill, and the employment position requirements may be seeking a “web designer.” The online social networking systems can normalize both of these to “web design and development,” and as normalized the member would match this particular employment requirement.

At 1050, the online social networking system receives a response from the employer regarding the member and the open employment position. If the employer exhibits an interest in the person for the employment position, then at 1051, the online social networking system transmits a message to the member informing the member of the employer's interest. At 1051A, the online social networking system conceals the identity of the employer prior to transmitting the message to the member indicating the interest of the employer in the person. This feature can be invoked at the request of the employer.

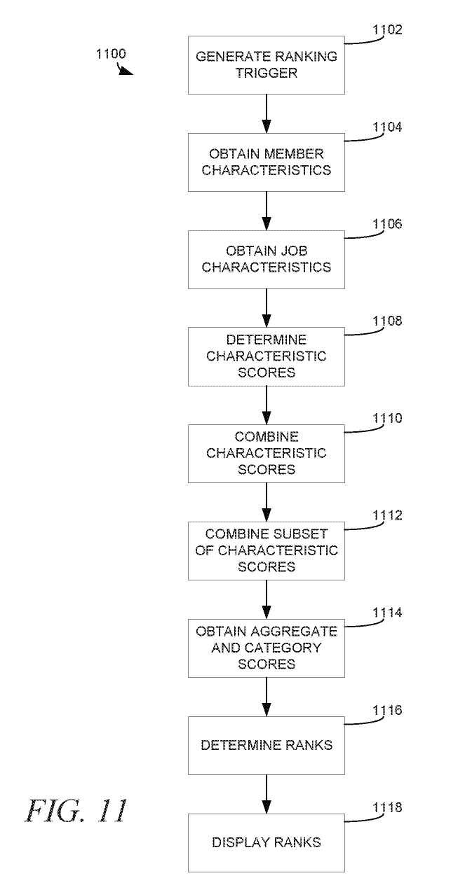

FIG. 11 is a flow diagram 1100 illustrating an embodiment that ranks a member of an online social network against others in connection with a current job posting. Though arranged substantially serially in the example of FIG. 11, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

At 1102, an online social networking system generates a trigger to rank a member against other members who have applied for a job on the online social networking system. In various examples, the trigger is via an offline system of the online social networking system determining that the job is relevant to the member, as disclosed herein. In such a circumstance, the subsequent operations are performed by the offline system. Alternatively, the trigger is via an online system of the online social networking system determining that the member has interacted with the job in some way, such as by applying for the job or viewing a page with information about the job. In such a circumstances, the subsequent operations are performed by the online system.

As with other embodiments noted herein, this embodiment can also function with a user of the online social network who is not a registered member of the online social networking system. For example, a non-member user can enter a profile that can be used in connection with analyzing current job postings for the user. In another embodiment, the member does not actively indicate an interest in the employment position, but rather the online social networking system automatically compares the member's profile to a current job posting. As indicated at 1106, in an embodiment, the employment position is posted in connection with the online social networking system (instead of a separate job posting service), and the profile of the member and profiles of other members are stored in connection with the online social networking system.

At 1104, a processor obtains member characteristics of the member from a database.

At 1106, the processor obtains job characteristics of the job from the database.

At 1108, the processor determines characteristic scores including, for each member characteristic, a characteristic score based on a relationship between the member characteristic and an associated one of the job characteristics. For instance, the job characteristic for current job skills may include keywords which may be searched against the member characteristic for current job skills and, for each match, one point assigned. Thus, by way of example, if the job characteristic for current job skill and the member characteristic for current job skill both include the keywords “computer programming”, “debugging”, and “C++”, but no other matches exist between the two member characteristics and job characteristics for current job skill, then a resultant numeric relationship may be three (3). Numeric relationships may be computed in similar fashion for the other member characteristic and job characteristic relationships.

In an example, the numeric relationship is the characteristic score. Alternatively, the numeric relationship may be multiplied by a coefficient to produce the associated characteristic score. The coefficients may be set by administrators of the online social networking system or may be determined over time based on the calculated ranks and the actual job application outcomes, e.g., determining how the numeric relationships should be adjusted to generate the most accurate ranks. In an example, the member skills overall has a coefficient of 1.66; member skills against a standardized list has a coefficient of 1.52; current job titles has a coefficient of 0.99; past job titles has a coefficient of 0.93; member personal summary has a coefficient of 0.76; current job summary has a coefficient of 0.45; current job skills has a coefficient of 0.47; past job summary has a coefficient of 0.42; past job skills −0.02; current title has a coefficient of 0.25; past titles has a coefficient of 0.19; current industry has a coefficient of 0.15; past industry has a coefficient of 0.13; and member summary has a coefficient of −0.43. It is noted that certain coefficients are negative; in such a circumstance, it may have been determined that the characteristic is actually a negative indicator.

At 1110, the characteristic scores are combined to obtain an aggregate job score. In an example, the characteristic scores are summed together, though it is noted that any suitable combination mechanism may be utilized, including variously multiplying and summing individual characteristic scores.

At 1112, a subset of the characteristic scores are combined to create a category score. In various examples the characteristics scores of each of the characteristics associated with a given category are summed or otherwise combined to obtain the category score. Thus, each category score is separately obtained based on the characteristics of that category.

At 1114, aggregate job scores and category scores associated with the job from other members of the online social networking system are obtained from the database. In an example, the aggregate job scores and category scores obtained are all or substantially all of those from any other member who have applied for the subject job.

At 1116, an aggregate rank of the aggregate job score in relation to the aggregate job scores of the other members and a category rank of the category score in relation to the category scores of the other members are determined. In various examples, the various aggregate job scores are ordered in ascending or descending order and the position of the aggregate job score of the subject member identified. The category rank is determined in the same manner for each category.

At 1118, the online social networking system causes the aggregate rank and the category rank to be displayed on a user interface screen of a user device associated with the member. The display of the aggregate and category ranks may be contingent on the respective ranks being in relation to a threshold. For instance, the rank may be greater than the threshold to be displayed on the user interface screen.

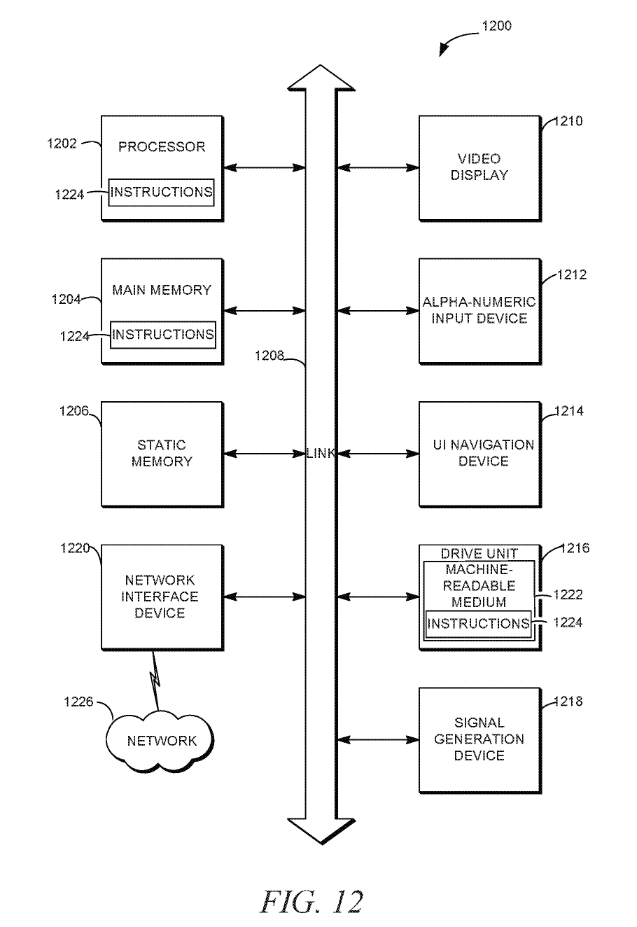

FIG. 12 is a block diagram illustrating components of a machine 1200, according to some example examples, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system and within which instructions 1224 (e.g., software) for causing the machine 1200 to perform any one or more of the methodologies discussed herein may be executed. In alternative examples, the machine 1200 operates as a standalone device or may be connected (e.g., networked) to other machines. In a networked deployment, the machine 1200 may operate in the capacity of a server machine or a client machine in a server-client network environment, or as a peer machine in a peer-to-peer (or distributed) network environment. The machine 1200 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include a collection of machines that individually or jointly execute the instructions 1224 to perform any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The machine 1200 may further include a graphics display 1210 (e.g., a plasma display panel (PDP), a light emitting diode (LED) display, a liquid crystal display (LCD), a projector, or a cathode ray tube (CRT)). The machine 1200 may also include an alphanumeric input device 1212 (e.g., a keyboard), a cursor control device 1214 (e.g., a mouse, a touchpad, a trackball, a joystick, a motion sensor, or other pointing instrument), a storage unit 1216, a signal generation device 1218 (e.g., a speaker), and a network interface device 1220.

The storage unit 1216 includes a machine-readable medium 1222 on which is stored the instructions 1224 (e.g., software) embodying any one or more of the methodologies or functions described herein. The instructions 1224 may also reside, completely or at least partially, within the main memory 1204, within the processor 1202 (e.g., within the processor's cache memory), or both, during execution thereof by the machine 1200. Accordingly, the main memory 1204 and the processor 1202 may be considered as machine-readable media. The instructions 1224 may be transmitted or received over a network 1226 via the network interface device 1220.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 1200), such that the instructions, when executed by one or more processors of the machine (e.g., processor 1202), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing.” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
obtaining, with a processor, from a database, member characteristics of a member of an online social networking system;
obtaining, with the processor, from the database, job characteristics of a job posted to the online social networking system;
determining, with the processor, characteristic scores including, for each member characteristic, a characteristic score based on a relationship between the member characteristic and an associated one of the job characteristics;
combining, with the processor, the characteristic scores to obtain an aggregate job score;
combining, with the processor, a subset of the characteristic scores to obtain a category score;
obtaining, with the processor, from the database, aggregate job scores and category scores associated with the job from other members of the online social networking system;
determining, with the processor, an aggregate rank of the aggregate job score in relation to the aggregate job scores and a category rank of the category score in relation to the category scores; and
causing, via a network interface device, an indication of the aggregate rank and the category rank to be displayed on a user device associated with the member.

2. The method of claim 1, wherein the online social networking system comprises an online system and an offline system, wherein the offline system is configured to determine the aggregate rank and the category rank based on a relevance of the job to the member.

3. The method of claim 1, wherein the online social networking system comprises an online system and an offline system, wherein the online system is configured to determine the aggregate rank and the category rank based on an interaction by the member, on the user device, with information related to the job.

4. The method of claim 3, wherein the interaction is at least one of applying for the job and selecting the job.

5. The method of claim 1, wherein the subset is a first subset, the category score is a first category score, and the category rank is a first category rank, and further comprising:
combining, with the processor, a second subset of the characteristic scores, different than the first subset, to obtain a second category score;
obtaining, with the processor, second category scores associated with the job from other members of the online social networking system; and
determining, with the processor, a second category rank of the category score in relation to the second category scores; and
wherein causing the indication further comprises causing the user device to display the second category rank as well as the aggregate rank and the first category rank.

6. The method of claim 1, wherein determining the characteristics scores comprises determining a numeric relationship between each member characteristic and the associated job characteristic and multiplying the numeric relationship by a coefficient associated with the characteristic score.

7. The method of claim 1, wherein causing the indication is based on the aggregate job rank relative to an aggregate threshold and the category rank relative to a category threshold.

8. A computer readable medium, comprising instructions which, when implemented by a processor, cause the processor to perform operations comprising:
obtain, from a database, member characteristics of a member of an online social networking system;
obtain, from the database, job characteristics of a job posted to the online social networking system;
determine, characteristic scores including, for each member characteristic, a characteristic score based on a relationship between the member characteristic and an associated one of the job characteristics,
combine the characteristic scores to obtain an aggregate job score;
combine a subset of the characteristic scores to obtain a category score;
obtain, from the database, aggregate job scores and category scores associated with the job from other members of the online social networking system;
determine an aggregate rank of the aggregate job score in relation to the aggregate job scores and a category rank of the category score in relation to the category scores; and
cause, via a network interface device, an indication of the aggregate rank and the category rank to be displayed on a user device associated with the member.

9. The computer readable medium of claim 8, wherein the online social networking system comprises an online system and an offline system, wherein the offline system is configured to determine the aggregate rank and the category rank based on a relevance of the job to the member.

10. The computer readable medium of claim 8, wherein the online social networking system comprises an online system and an offline system, wherein the online system is configured to determine the aggregate rank and the category rank based on an interaction by the member, on the user device, with information related to the job.

11. The computer readable medium of claim 10, wherein the interaction is at least one of applying for the job and selecting the job.

12. The computer readable medium of claim 8, wherein the subset is a first subset, the category score is a first category score, and the category rank is a first category rank, and further comprising instructions which cause the processor to perform operations comprising:
combining, with the processor, a second subset of the characteristic scores, different than the first subset, to obtain a second category score;
obtaining, with the processor, second category scores associated with the job from other members of the online social networking system; and
determining, with the processor, a second category rank of the category score in relation to the second category scores; and
wherein causing the indication further comprises causing the user device to display the second category rank as well as the aggregate rank and the first category rank.

13. The computer readable medium of claim 8, wherein determining the characteristics scores comprises determining a numeric relationship between each member characteristic and the associated job characteristic and multiplying the numeric relationship by a coefficient associated with the characteristic score.

14. The computer readable medium of claim 8, wherein causing the indication is based on the aggregate job rank relative to an aggregate threshold and the category rank relative to a category threshold.

15. A system, comprising
a computer readable medium, comprising instructions which, when implemented by a processor, cause the processor to perform operations comprising:
obtain, from a database, member characteristics of a member of an online social networking system;
obtain, from the database, job characteristics of a job posted to the online social networking system;
determine, characteristic scores including, for each member characteristic, a characteristic score based on a relationship between the member characteristic and an associated one of the job characteristics;
combine the characteristic scores to obtain an aggregate job score;
combine a subset of the characteristic scores to obtain a category score;
obtain, from the database, aggregate job scores and category scores associated with the job from other members of the online social networking system;
determine an aggregate rank of the aggregate job score in relation to the aggregate job scores and a category rank of the category score in relation to the category scores; and
cause, via a network interface device, an indication of the aggregate rank and the category rank to be displayed on a user device associated with the member.

16. The system of claim 15, wherein the online social networking system comprises an online system and an offline system, wherein the processor is a component of the offline system, and wherein the operations cause the processor to determine the aggregate rank and the category rank based on a relevance of the job to the member.

17. The system of claim 15, wherein the online social networking system comprises an online system and an offline system, wherein the processor is a component of the online system, and wherein the operations cause the processor to determine the aggregate rank and the category rank based on an interaction by the member, on the user device, with information related to the job.

18. The system of claim 17, wherein the interaction is at least one of applying for the job and selecting the job.

19. The system of claim 15, wherein the subset is a first subset, the category score is a first category score, and the category rank is a first category rank, and further comprising instructions which cause the processor to perform operations comprising:
combining, with the processor, a second subset of the characteristic scores, different than the first subset, to obtain a second category score;
obtaining, with the processor, second category scores associated with the job from other members of the online social networking system; and
determining, with the processor, a second category rank of the category score in relation to the second category scores; and
wherein causing the indication further comprises causing the user device to display the second category rank as well as the aggregate rank and the first category rank.

20. The system of claim 15, wherein determining the characteristics scores comprises determining a numeric relationship between each member characteristic and the associated job characteristic and multiplying the numeric relationship by a coefficient associated with the characteristic score.
